(19) United States
(12) Patent Application Publication
(10) Pub. No.: US 2024/0135569 A1
(43) Pub. Date: Apr. 25, 2024

(54) METHOD FOR PARAMETERIZING A SCENE

(71) Applicant: ROBERT BOSCH GMBH, Stuttgart (DE)

(72) Inventors: Matthias Wacker, Hildesheim (DE); Michael Kessler, Diekholzen (DE); Bjoern Scheuermann, Sarstedt (DE); Johann Maas, Bad Salzdetfurth (DE); Martin Mechelke, Bovenden (DE); Omar Alaa EI-Din, Hannover (DE); Steffen Brueggert, Hildesheim (DE)

(21) Appl. No.: 18/547,966

(22) PCT Filed: May 10, 2022
(86) PCT No.: PCT/EP2022/062780

§ 371 Date: Aug. 24, 2023

(30) Foreign Application Priority Data
Jun. 9, 2021 (DE) 10 2021 205 836.1

(51) Int. Cl. G06T 7/60; G06T 7/50; G06V 10/764; G06V 20/58

(52) U.S. Cl. CPC G06T 7/60; G06T 7/50; G06V 10/764; G06V 20/58; G06T 2207/20076; G06T 2207/30252

(57) ABSTRACT

A method for parameterizing a scene having a surface, on which at least two objects are disposed, using a camera disposed at a distance from the objects. The method includes: a) using the camera, producing an image of the scene, the image containing image data regarding the objects; b) recognizing at least two objects in the image by evaluation of the image data and assigning each recognized object to a specific object class; c) estimating an object size of each of the at least two recognized objects in accordance with at least one surface parameter characterizing the surface; d) for each of the at least two objects: calculating an individual probability that the object has the object size estimated in measure c); e) calculating a scene probability from the at least two calculated individual probabilities.

### FIELD

The present invention relates to a method for parameterizing a scene having a surface and to a control device designed/programmed to carry out the method. The present invention also relates to a motor vehicle having such a control device.

### BACKGROUND INFORMATION

The knowledge of the geometry of a surface or of a scene in which such a surface is present proves to be significant especially in connection with vehicle assistance systems for motor vehicles.

Conventional methods that evaluate an image of the scene produced by means of a camera or the like estimate the object size of objects recognized in the image and the distance thereof from the camera in accordance with different input parameters, which in turn depend on a respectively assumed geometry of the surface. The accuracy of the estimation thus depends greatly on the assumed surface geometry and is therefore prone to errors.

### SUMMARY

It is an object of the present invention to create an improved embodiment for a method of the type explained at the outset, which in particular has improved accuracy with which the geometry of a surface or of a scene having such a surface can be ascertained.

This object may be achieved by features of the present invention. Preferred embodiments of the present invention are disclosed herein.

According to an example embodiment of the present invention, the method includes calculating the object size and object distance in an image produced by means of a camera in accordance with a parameter characterizing the surface geometry of a surface on which the objects are disposed. It is to be regarded as importance to the present invention that said objects are recognized by means of image recognition measures and assigned to certain predetermined object classes. A probability distribution of the size of the object assigned to the particular object class is predetermined for each predetermined object class. Thus, for the estimated object size of each recognized object, a probability that the recognized object has the calculated object size can be calculated by means of the known probability distribution. A so-called scene probability can be calculated from the individual probability calculable for each object in this way, for example by product calculation. The resulting value for the scene probability is a measure of whether the parameter characterizing the surface geometry and selected at the outset clearly reproduces the surface geometry actually present. If the calculation of the scene probability explained above is carried out for different values of the parameter characterizing the geometry of the surface, then the value at which the calculated scene probability assumes a maximum value is preferably classified as best characterizing the actual surface geometry. With the aid of the use proposed here of predetermined probability distributions for the object size of objects of different object classes, the geometry of a surface with objects can thus be estimated particularly precisely and with a significantly reduced error compared with conventional methods.

The method according to an example embodiment of the present invention described herein for parameterizing a scene having a surface on which at least two objects are disposed, by means of a camera disposed at a distance from the objects, comprises the five measures a) to e) explained below.

According to a first measure a), an image of the scene is produced by means of the camera, the image containing image data relating to the at least two objects. In a further, second measure b), at least two objects are recognized in the image produced, and the objects recognized in the image by evaluation of the image data are assigned to a specific object class. In a third measure c), an object size of each of the at least two recognized objects is estimated in accordance with at least one surface parameter characterizing the surface. In a fourth measure d), for each of the at least two objects, an individual probability that the object has the object size estimated in measure c) is calculated. Finally, in a fifth measure e), a scene probability is calculated from the at least two calculated individual probabilities.

According to a preferred embodiment of the present invention, the at least one surface parameter characterizing the surface is an angle that is formed by the main ray extending from the camera to the object with a planar reference surface on which the object is disposed.

According to a preferred embodiment of the present invention, by varying the at least one surface parameter characterizing the surface, the scene probability is maximized and the value of the at least one parameter parameterizing the surface at which the scene probability assumes a maximum value is output as a result of the method. In this way, the value of the surface parameter that best describes the evaluated scene can be determined with particularly high accuracy.

The scene probability can particularly expediently be calculated by multiplying the at least two calculated individual probabilities by one another. Thus, the scene probability can be ascertained with only very little computing effort.

According to an advantageous development of the present invention, in order to ascertain the sought maximum value, at least the measures c) to e) are carried out iteratively, varying the at least one parameter characterizing the surface. This measure also entails a not inconsiderable simplification of the method according to the present invention.

Expediently, in order to estimate the object size of each object in measure c), a distance of the object from the camera can be estimated and then the object size of the object can be calculated as a function of the distance. Such an estimation of the sought distance is possible by means of relatively easy-to-use ray-optical calculations and can thus be carried out easily, in particular without major computing effort. Particularly preferably, the distance can be estimated in accordance with the at least one parameter parameterizing the surface. Thus, the parameter parameterizing the surface remains the only free parameter of the entire method.

The present invention also relates to a control device comprising a data processing unit and a memory unit. The control device according to the present invention is designed and/or programmed to carry out the method explained above, and therefore the above-explained advantages of the method according to the present invention also result for the control device according to the present invention.

The present invention also relates to a motor vehicle having a camera, the field of view of which is oriented toward the surroundings of the motor vehicle, in particular the area in front of the motor vehicle, so that the camera can produce an image of the surroundings of the motor vehicle during operation. The motor vehicle also comprises a control device according to the present invention, which is connected to the camera in a data-transmitting manner. Thus, the above-explained advantages of the method according to the present invention are also transferred to the motor vehicle according to the present invention.

Further features and advantages of the present invention can be found in the disclosure herein.

It is self-evident that the features mentioned above and those still to be explained below can be used not only in the combination specified in each case, but also in other combinations or alone, without departing from the scope of the present invention.

Preferred exemplary embodiments of the present invention are illustrated in the figures and are explained in more detail in the following description, wherein the same reference signs refer to identical or similar or functionally identical components.

### BRIEF DESCRIPTION OF THE DRAWINGS

FIG. 1 schematically shows, by way of example, a typical scene having an object with an object size to be determined, for which the method according to the present invention is used.

FIG. 2 schematically shows a diagram supplementing FIG. 1, on the basis of which a calculation of the distance of the object from the camera and the calculation of the object size resulting from the calculated distance is illustrated.

FIG. 3 schematically shows a highly simplified flowchart of the method according to an example embodiment of the present invention.

### DETAILED DESCRIPTION OF EXAMPLE EMBODIMENTS

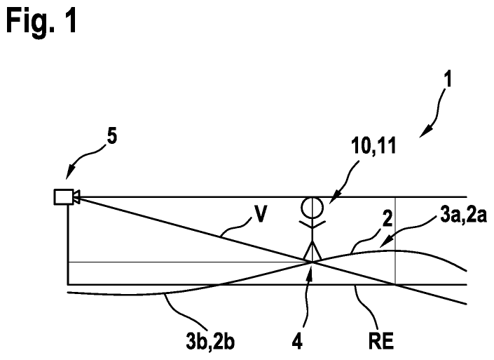

FIG. 1 shows a schematic diagram of a typical scene 1 in which the method according to the present invention can be used. The method is used to parameterize a surface 2 present in the scene 1, which surface does not have to be flat but can be designed with a curved surface profile, as shown in FIG. 1. In FIG. 1, the surface 2 comprises a first surface portion 2a, which forms an elevation 3a, and a second surface portion 2b, which adjoins the first surface portion 2a and forms a depression 3b. An object 10—in the example a person 11—is disposed on the surface 2 at a transition 4 between the elevation 3a and the depression 3b.

A camera 5 is present in the region of the depression 3b, at a distance from the object 10, the field of view of which camera is oriented toward the scene 1 having the surface 2 so that the camera 5 can produce an image of the surface 2 with the object 10 disposed therein. The camera 5 can be, for example, a video camera, which can be installed in a motor vehicle (not shown).

Two or more objects 10 are typically disposed in the scene 1, but only a single object 10 is shown in FIG. 1 for the sake of simplicity.

As shown in FIG. 1, the profile of the surface 2, in particular of the depression 3b and of the elevation 3a, can be parameterized by an angle α that is formed by the main ray S extending from the camera 5 to the object 10 with a planar reference surface RE on which the object 10 is disposed.

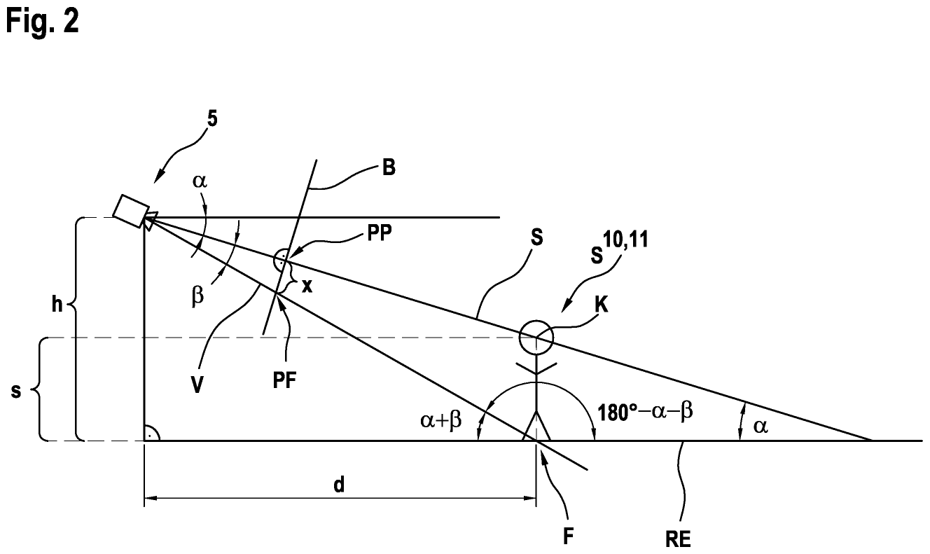

In FIG. 2, the height of the camera 5, i.e. its vertical distance from the reference plane locking element, is denoted by h. In addition to the angle α already mentioned, which describes the inclination of the camera 5 relative to the reference plane RE, the angle between the main ray S of the camera 5 and the visual ray V extending from the camera 5 to the foot point F is defined as an angle β. The foot point F in turn is the intersection point of the object 10 with the reference plane RE.

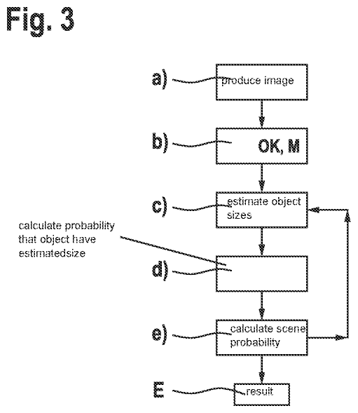

FIG. 3 shows a flowchart of the method according to the present invention. In a first measure a) of the method, an image of scene 1 is produced by means of the camera 5. This image contains image data relating to the surface 2 and also the objects 10 disposed on the surface 2. According to a second measure b) following the first measure a), at least two of the objects 10 present in the scene 1 are recognized by evaluation of the image data produced by means of the camera 5. Each recognized object 10 is assigned to a specific object class OK from a predetermined quantity M of such object classes OK. Possible object classes are, for example, “motor vehicles”, “pedestrians”, “traffic signs”, “traffic bollards”, “traffic lights”, etc.

In the course of the method, the object class OK to which each recognized object 10 is to be assigned can be determined conventionally by means of pattern recognition, for example. In the example of FIG. 1, the recognized object 10 shape is assigned to the object class “pedestrians”. This is carried out in this way for all recognized objects 10 in measure b). In a further measure c), for each recognized object 10, the object size of the recognized object 10 is estimated in accordance with theangle α characterizing the surface.

The calculation of the object size as a function of the angle α, i.e., the angle between the reference plane RE and the main ray S from the camera 5 to the head point K of the object 10, is explained below with reference to FIG. 2. To this end, conventional relationships from ray optics are applied.

In the following, β is the intermediate angle between the visual ray V that extends from the camera 5 to a foot point F at which the object 10 touches the reference plane RE.

In addition, the main point PP is the point disposed at the distance f from the camera 5 on the main ray S, f being the focal length of the camera 5, expressed in optical pixels of the image. An image plane B runs perpendicular to the main ray S through the main point PP. The point PF is the point at which the visual ray V of the camera 5 intersects with the plane B.

The following applies:

β=arctan((X)/f) (1),

where X is the distance of the main point PP from the point PF, both of which are disposed on the image plane B.

The estimated distance d of the object 10 from the camera 5 results in accordance with theangle α as:

d(α)=h*tan (α+β) (2),

where h is the distance of the camera 5 from the reference plane RE.

The estimated object size s, i.e., the distance between the head point K and the foot point F of the object 10, results in accordance with the angle α as:

S(α)=d(a)*s_p/f (3),

where f is the focal length of the camera 5, and s_p is an object size of the object 10 in image pixels on the image produced by means of the camera 5.

As explained above, the object size s is estimated for each object 10 recognized in measure b). For example, if four different objects 10 are recognized in measure b), four object sizes s1(α), s2(α), s3(α), s4(α) are estimated.

For the different object classes OK, a statistic regarding the object size distribution thereof can be formed, so that the estimated object size s(α) explained above can be assigned a probability of occurrence P_{OK} (s(α)), which can in turn be calculated from a predetermined probability distribution. This applies to all recognized objects and thus to all estimated object sizes. If the different objects are assigned to different object classes, they are also assigned to different object size distributions.

In the course of a further measure d), for each object recognized in measure b), an individual probability P(s(α)) that the object has the object size estimated in measure c) is calculated taking into account the classification performed in measure b). For this purpose, the previously known probability distribution must be used for each object class encountered, and the individual probability P_{OK} (s(a)) must be calculated therefrom. For example, if four objects are recognized in measure b), four individual probabilities P₁(s(α)), P₂(s(α)), P₃(s(α)), P₄(s(α)) are calculated.

Finally, in a further measure e), a scene probability P_{ges} (α) is calculated from the individual probabilities P₁(s(α)), P₂(s(α)), P₃(s(α)), P₄(s(α)) calculated in measure e) for each recognized object 10. The scene probability P_{ges} (α) can be calculated, for example, by multiplication of the individual probabilities P₁(s(α)), P₂(s(α)), P₃(s(α)), P₄(s(α)) calculated in measure d), i.e., P_{ges} (α)=P₁(s(α))*P₂(s(α))*P₃(s(α))*P₄(s(α)).

By varying the at least one surface parameter characterizing the surface, i.e., theangle α in the example, the scene probability P_{ges} (α) is now maximized in the method according to the present invention. As result E of the method is the value of the angle α at which at least one parameter parameterizing the surface is output as the result of the method at which the scene probability P_{ges} (α) assumes a maximum value, i.e., E=max (P_{ges} (α)) for all a under consideration. To ascertain the sought maximum value max (P_{ges} (α)), at least measures c) to e) can be carried out iteratively, varying the at least one parameter characterizing the surface, i.e, the angle α. The value ascertained as the result E in this way for theangle α can be regarded as the value that best describes the actual scene.

1-9. (canceled)

10. A method for parameterizing a scene having a surface on which at least two objects are disposed, using a camera disposed at a distance from the objects, the method comprising the following steps:
a) producing, using the camera, an image of the scene, the image containing image data regarding the objects;
b) recognizing at least two objects in the image by evaluation of the image data and assigning each recognized object to a specific object class;
c) estimating an object size of each of the at least two recognized objects in accordance with at least one surface parameter characterizing the surface;
d) calculating, for each of the at least two object, an individual probability that the object has the object size estimated in step c); and
e) calculating a scene probability from the at least two calculated individual probabilities.

11. The method according to claim 10, wherein the at least one surface parameter characterizing the surface is an angle that is formed by a main ray extending in a straight line from the camera to a head point of each of the recognized objects, with a reference plane on which the recognized object is disposed.

12. The method according to claim 11, wherein the reference plane is at a foot point of the recognized object, opposite the head point.

13. The method according to claim 10, wherein by varying the at least one surface parameter characterizing the surface, the scene probability is maximized and a value of the at least one parameter parameterizing the surface at which the scene probability assumes a maximum value is output as a result of the method.

14. The method according to claim 10, wherein the scene probability is calculated by multiplying the at least two calculated individual probabilities by one another.

15. The method according to claim 13, wherein, to ascertain the maximum value, at least the measures c) to e) are carried out iteratively, varying the at least one parameter characterizing the surface.

16. The method according to claim 10, wherein, to estimate the object size of each recognized object in step c), a distance of the recognized object from the camera is estimated and the object size of the recognized object is calculated as a function of the distance.

17. The method according to claim 16, wherein the distance is estimated in accordance with the at least one parameter parameterizing the surface.

18. A control device for a motor vehicle, comprising:
a data processing unit; and
a memory unit;
wherein the control device is configured to parameterize a scene having a surface on which at least two objects are disposed, using a camera disposed at a distance from the objects, the control unit configured to:
a) produce, using the camera, an image of the scene, the image containing image data regarding the objects;
b) recognize at least two objects in the image by evaluation of the image data and assigning each recognized object to a specific object class;
c) estimate an object size of each of the at least two recognized objects in accordance with at least one surface parameter characterizing the surface;
d) calculate, for each of the at least two object, an individual probability that the object has the object size estimated in c); and
e) calculate a scene probability from the at least two calculated individual probabilities.

19. A motor vehicle, comprising:
a camera, a field of view of which is oriented toward surroundings of the motor vehicle an an area in front of the motor vehicle, so that the camera can produce an image of the surroundings during operation; and
a control device connected to the camera in a data-transmitting manner, the control device including:
a data processing unit; and
a memory unit;
wherein the control device is configured to parameterize a scene having a surface on which at least two objects are disposed, using a camera disposed at a distance from the objects, the control unit configured to:
a) produce, using the camera, an image of the scene, the image containing image data regarding the objects;
b) recognize at least two objects in the image by evaluation of the image data and assigning each recognized object to a specific object class;
c) estimate an object size of each of the at least two recognized objects in accordance with at least one surface parameter characterizing the surface;
d) calculate, for each of the at least two object, an individual probability that the object has the object size estimated in c); and
e) calculate a scene probability from the at least two calculated individual probabilities.
